(19) United States
(12) Patent Application Publication
(10) Pub. No.: US 2026/0129520 A1
(43) Pub. Date: May 7, 2026

(54) SEAMLESS ROAMING

(71) Applicant: QUALCOMM Incorporated, San Diego, CA (US)

(72) Inventors: Giovanni CHISCI, San Diego, CA (US); Abhishek Pramod PATIL, San Diego, CA (US); Sai Yiu Duncan HO, San Diego, CA (US); Alfred ASTERJADHI, San Diego, CA (US); Gaurang NAIK, San Diego, CA (US); Sanket Sanjay KALAMKAR, San Diego, CA (US); Sherief HELWA, San Diego, CA (US); George CHERIAN, San Diego, CA (US); Krishnakumar MUTHUSAMY, Danville, CA (US); Yogesh SHEKAR, Milpitas, CA (US); Vikram PHOGAT, Fremont, CA (US); Tushnim BHATTACHARYYA, San Diego, CA (US)

(21) Appl. No.: 19/380,852

(22) Filed: Nov. 5, 2025

Related U.S. Application Data
(60) Provisional application No. 63/717,632, filed on Nov. 7, 2024.

(51) Int. Cl. H04W 36/00; H04W 36/18

(52) U.S. Cl. CPC H04W 36/0016; H04W 36/0033; H04W 36/00835; H04W 36/18

(57) ABSTRACT

Various aspects of the present disclosure generally relate to wireless communication. In some aspects, a wireless device may transmit a first request message that requests preparation of a service transition from a first access point (AP) multi-link device (MLD) to a second AP MLD among one or more candidate AP MLDs. The wireless device may receive a first response message that indicates that one candidate AP MLD, among the candidate AP MLDs, is the second AP MLD prepared for the service transition. The wireless device may transmit a second request message to the first AP MLD or the second AP MLD. The wireless device may receive a second response message that indicates completion of the service transition to the second AP MLD and that the second AP MLD is ready for data communications. Numerous other aspects are described.

### CROSS-REFERENCE TO RELATED APPLICATION

This Patent Application claims priority to U.S. Provisional Patent Application No. 63/717,632, filed on Nov. 7, 2024, entitled “SEAMLESS ROAMING,” and assigned to the assignee hereof. The disclosure of the prior Application is considered part of and is incorporated by reference into this Patent Application.

### TECHNICAL FIELD

This disclosure relates generally to wireless communication, and more specifically, to seamless roaming.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

Some aspects described herein relate to a method of wireless communication performed by a wireless device. The method may include transmitting a first request message that requests preparation of a service transition from a first access point (AP) multi-link device (MLD) to a second AP MLD among one or more candidate AP MLDs, where the first AP MLD and each of one or more candidate AP MLDs respectively includes one or more associated APs that are operating on a link of its respective AP MLD. The method may include receiving a first response message that indicates that one candidate AP MLD, among the one or more candidate AP MLDs, is the second AP MLD prepared for the service transition. The method may include transmitting a second request message to the first AP MLD or the second AP MLD. The method may include receiving a second response message that indicates completion of the service transition to the second AP MLD and that the second AP MLD is ready for data communications.

Some aspects described herein relate to a method of wireless communication performed by a first AP MLD. The method may include receiving a first request message that requests preparation of a service transition from the first AP MLD to a second AP MLD among one or more candidate AP MLDs, where the first AP MLD and each of one or more candidate AP MLDs respectively includes one or more associated APs that are operating on a link of its respective AP MLD. The method may include performing a link addition for one or more first candidate AP MLDs selected from the one or more candidate AP MLDs. The method may include transmitting a first response message that indicates that the one or more first candidate AP MLDs are prepared for the service transition.

Some aspects described herein relate to a method of wireless communication performed by a second AP MLD. The method may include receiving a first request message that requests preparation of a service transition from a first AP MLD to the second AP MLD, where the second AP MLD is among one or more candidate AP MLDs, where the first AP MLD and each of one or more candidate AP MLDs respectively includes one or more associated APs that are operating on a link of its respective AP MLD. The method may include receiving a request to perform link addition and context for communications. The method may include transmitting a link addition confirmation.

Some aspects described herein relate to an apparatus for wireless communication at a wireless device. The apparatus may include one or more memories and one or more processors coupled to the one or more memories. The one or more processors may be individually or collectively configured to transmit a first request message that requests preparation of a service transition from a first AP MLD to a second AP MLD among one or more candidate AP MLDs, where the first AP MLD and each of one or more candidate AP MLDs respectively includes one or more associated APs that are operating on a link of its respective AP MLD. The one or more processors may be individually or collectively configured to receive a first response message that indicates that one candidate AP MLD, among the one or more candidate AP MLDs, is prepared for the service transition. The one or more processors may be individually or collectively configured to transmit a second request message to the first AP MLD or the second AP MLD. The one or more processors may be individually or collectively configured to receive a second response message that indicates completion of the service transition to the second AP MLD and that the second AP MLD is ready for data communications.

Some aspects described herein relate to an apparatus for wireless communication at a first AP. The apparatus may include one or more memories and one or more processors coupled to the one or more memories. The one or more processors may be individually or collectively configured to receive a first request message that requests preparation of a service transition from the first AP MLD to a second AP MLD among one or more candidate AP MLDs, where the first AP MLD and each of one or more candidate AP MLDs respectively includes one or more associated APs that are operating on a link of its respective AP MLD. The one or more processors may be individually or collectively configured to perform a link addition for one or more first candidate AP MLDs selected from the one or more candidate AP MLDs. The one or more processors may be individually or collectively configured to transmit a first response message that indicates that the one or more first candidate AP MLDs are prepared for the service transition.

Some aspects described herein relate to an apparatus for wireless communication at a second AP. The apparatus may include one or more memories and one or more processors coupled to the one or more memories. The one or more processors may be individually or collectively configured to receive a first request message that requests preparation of a service transition from a first AP MLD to the second AP MLD, wherein the second AP MLD is among one or more candidate AP MLDs, where the first AP MLD and each of one or more candidate AP MLDs respectively includes one or more associated APs that are operating on a link of its respective AP MLD. The one or more processors may be individually or collectively configured to receive a request to perform link addition and context for communications. The one or more processors may be configured to transmit a link addition confirmation.

Some aspects described herein relate to a non-transitory computer-readable medium that stores a set of instructions for wireless communication by a wireless device. The set of instructions, when executed by one or more processors of the wireless device, may cause the wireless device to transmit a first request message that requests preparation of a service transition from a first AP MLD to a second AP MLD among one or more candidate AP MLDs, where the first AP MLD and each of one or more candidate AP MLDs respectively includes one or more associated APs that are operating on a link of its respective AP MLD. The set of instructions, when executed by one or more processors of the wireless device, may cause the wireless device to receive a first response message that indicates that one candidate AP MLD, among the one or more candidate AP MLDs, is the second AP MLD prepared for the service transition. The set of instructions, when executed by one or more processors of the wireless device, may cause the wireless device to transmit a second request message to the first AP MLD or the second AP MLD, where the second AP MLD is among the one or more first candidate AP MLDs. The set of instructions, when executed by one or more processors of the wireless device, may cause the wireless device to receive a second response message that indicates completion of the service transition to the second AP MLD and that the second AP MLD is ready for data communications.

Some aspects described herein relate to a non-transitory computer-readable medium that stores a set of instructions for wireless communication by a first AP. The set of instructions, when executed by one or more processors of the AP, may cause the AP to receive a first request message that requests preparation of a service transition from the first AP MLD to a second AP MLD among one or more candidate AP MLDs, wherein the first AP MLD and each of one or more candidate AP MLDs respectively includes one or more associated APs that are operating on a link of its respective AP MLD. The set of instructions, when executed by one or more processors of the AP, may cause the AP to perform a link addition for one or more first candidate AP MLDs selected from the one or more candidate AP MLDs. The set of instructions, when executed by one or more processors of the AP, may cause the AP to transmit a first response message that indicates that the one or more first candidate AP MLDs are prepared for the service transition.

Some aspects described herein relate to a non-transitory computer-readable medium that stores a set of instructions for wireless communication by a second AP. The set of instructions, when executed by one or more processors of the AP, may cause the AP to receive a first request message that requests preparation of a service transition from a first AP MLD to the second AP MLD, wherein the second AP MLD is among one or more candidate AP MLDs, where the first AP MLD and each of one or more candidate AP MLDs respectively includes one or more associated APs that are operating on a link of its respective AP MLD. The set of instructions, when executed by one or more processors of the AP, may cause the AP to receive a request to perform link addition and context for communications. The set of instructions, when executed by one or more processors of the AP, may cause the AP to transmit a link addition confirmation.

Some aspects described herein relate to an apparatus for wireless communication. The apparatus may include means for transmitting a first request message that requests preparation of a service transition from a first AP MLD to a second AP MLD among one or more candidate AP MLDs, where the first AP MLD and each of one or more candidate AP MLDs respectively includes one or more associated APs that are operating on a link of its respective AP MLD. The apparatus may include means for receiving a first response message that indicates that one candidate AP MLD, among the one or more candidate AP MLDs, is the second AP MLD prepared for the service transition. The apparatus may include means for transmitting a second request message to the first AP MLD or the second AP MLD. The apparatus may include means for receiving a second response message that indicates completion of the service transition to the second AP MLD and that the second AP MLD is ready for data communications.

Some aspects described herein relate to a first apparatus for wireless communication. The apparatus may include means for receiving a first request message that requests preparation of a service transition from the first apparatus to a second apparatus among one or more candidate AP MLDs, where the first apparatus and each of one or more candidate AP MLDs respectively includes one or more associated APs that are operating on a link of its respective AP MLD; means for performing a link addition for one or more first candidate AP MLDs selected from the one or more candidate AP MLDs; and means for transmitting a first response message that indicates that the one or more first candidate AP MLDs are prepared for the service transition.

Some aspects described herein relate to a second apparatus for wireless communication. The apparatus may include means for receiving a first request message that requests preparation of a service transition from a first apparatus to the second apparatus, wherein the second AP MLD is among one or more candidate AP MLDs, where the first apparatus and each of one or more candidate AP MLDs respectively includes one or more associated APs that are operating on a link of its respective AP MLD; means for receiving a request to perform link addition and context for communications; and means for transmitting a link addition confirmation.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example protocol data unit usable for wireless communication between a wireless access point (AP) and one or more wireless stations (STAs).

FIG. 3 is a diagram illustrating an example of seamless roaming.

FIG. 4 is a diagram illustrating an example of a sequence of messages.

FIG. 5 is a diagram illustrating an example of another preparation phase iteration.

FIG. 6 is a diagram illustrating an example of downlink (DL) link operations with a default traffic-identifier-to-link mapping (TTLM).

FIG. 7 is a diagram illustrating an example of DL link operations without a default TTLM.

FIG. 8 is a diagram illustrating an example of DL link operations with a default TTLM with cross-link and cross-AP indication.

FIG. 9 is a diagram illustrating an example process performed, for example, at a wireless device or an apparatus of a wireless device.

FIG. 10 is a diagram illustrating an example process performed, for example, at an AP or an apparatus of an AP.

FIG. 11 is a diagram illustrating an example process performed, for example, at an AP or an apparatus of an AP.

FIG. 12 shows a block diagram of an example wireless device that supports seamless roaming.

FIG. 13 shows a block diagram of an example AP that supports seamless roaming.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others. The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Some access points (APs) and wireless devices or stations (STAs) are capable of multi-link operation (MLO). An MLO-capable device may be referred to as a multi-link device (MLD). In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various configuration parameters. An MLD may include a single upper medium access control (MAC) entity, and can include, for example, three independent lower MAC entities and three associated independent physical (PHY) entities for respective links in the 2.4 GHz, 5 GHz, and 6 GHz bands. This architecture may enable a single association process and security context. An AP MLD may include multiple APs each configured to communicate on a respective communication link with a respective one of multiple STAs of a non-AP MLD (also referred to as a “STA MLD”).

Seamless roaming for a wireless device or client (non-AP MLD) may include roaming (service transition to be served) from a current AP MLD to a target AP MLD. A seamless mobility domain (SMD) may be defined for seamless roaming, such that AP MLDs within the same SMD can obtain a higher level of coordination for the client service transition to be as smooth as possible. The SMD may preserve the context necessary for resuming communications after the service transition and minimize the interruption of service. At the core of roaming, there is an update of distribution system (DS) mapping (connecting different APs together) for the client, to set which AP MLD the DS should send data to for delivery to the client. If all the operations like context transfer and link setup are performed during one phase, the suspension of transmissions may be too long and may introduce latency.

Various aspects relate generally to AP MLDs. Some aspects more specifically relate to, a wireless device (client, non-AP MLD) and AP MLDs that exchange messages in different phases, such that the client can seamlessly roam from a current AP MLD to a target AP MLD. In phase 1, most of the burden of the roaming setup is taken care of without service interruptions. In phase 2, the service transition is consolidated (e.g., DS mapping change) and fast as possible for minimal overall service interruption. A four message handshake may perform the seamless roaming between two AP MLDs within the same SMD. The handshake may include roaming preparation (Phase 1, Msg1 and Msg2), the service transition (Phase 2, Msg3 and Msg4), and a cleanup (Phase 3).

Particular aspects of the subject matter described in this disclosure can be implemented to realize one or more of the following potential advantages. By using the sequence of messages in the four message handshake, the wireless device may reduce the latency in starting communications after seamless roaming.

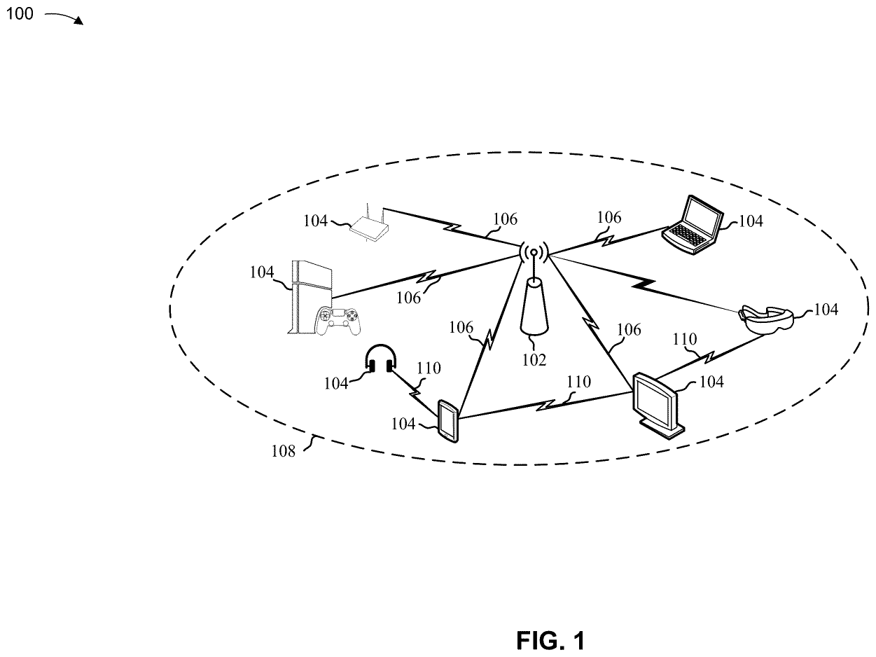

FIG. 1 shows a pictorial diagram of an example wireless communication network 100. According to some aspects, the wireless communication network 100 can be an example of a WLAN, such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth protocols or other wireless technologies, to provide greater or enhanced network coverage or to provide or enable other capabilities, functionality, applications or services.

The wireless communication network 100 may include numerous wireless communication devices including at least one wireless AP 102 and any number of STAs 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP MLD), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a RAN, including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a MAC address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHz, 6 GHz, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the PHY and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHz, 6 GHz, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz-71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHz, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields).

Some APs and STAs, such as, for example, the AP 102 and STAs 104 described with reference to FIG. 1, are capable of MLO. For example, the AP 102 and STAs 104 may support MLO as defined in one or both of the IEEE 802.11be and 802.11bn standard amendments. An MLO-capable device may be referred to as a MLD. In some examples, MLO supports establishing multiple different communication links (such as a first link on the 2.4 GHz band, a second link on the 5 GHz band, and the third link on the 6 GHz band) between MLDs. Each communication link may support one or more sets of channels or logical entities. For example, an AP MLD may set, for each of the communication links, a respective operating bandwidth, one or more respective primary channels, and various BSS configuration parameters. An MLD may include a single upper MAC entity, and can include, for example, three independent lower MAC entities and three associated independent PHY entities for respective links in the 2.4 GHz, 5 GHz, and 6 GHz bands. This architecture may enable a single association process and security context. An AP MLD may include multiple APs 102 each configured to communicate on a respective communication link with a respective one of multiple STAs 104 of a non-AP MLD (also referred to as a “STA MLD”).

To support MLO techniques, an AP MLD and a STA MLD may exchange MLO capability information (such as supported aggregation types or supported frequency bands, among other information). In some examples, the exchange of information may occur via a beacon frame, a probe request frame, a probe response frame, an association request frame, an association response frame, another management frame, a dedicated action frame, or an operating mode indicator (OMI), among other examples. In some examples, an AP MLD may designate a specific channel of one link in one of the bands as an anchor channel on which it transmits beacons and other control or management frames periodically. In such examples, the AP MLD also may transmit shorter beacons (such as ones which may contain less information) on other links for discovery or other purposes.

MLDs may exchange packets on one or more of the communications links dynamically and, in some instances, concurrently. MLDs also may independently contend for access on each of the communication links, which achieves latency reduction by enabling the MLD to transmit its packets on the first communication link that becomes available. For example, “alternating multi-link” may refer to an MLO mode in which an MLD may listen on two or more different high-performance links and associated channels concurrently. In an alternating multi-link mode of operation, an MLD may alternate between use of two links to transmit portions of its traffic. Specifically, an MLD with buffered traffic may use the first link on which it wins contention and obtains a TXOP to transmit the traffic. While such an MLD may in some examples be capable of transmitting or receiving on only one communication link at any given time, having access opportunities via two different links enables the MLD to avoid congestion, reduce latency, and maintain throughput.

Multi-link aggregation (MLA) (which also may be referred to as carrier aggregation (CA)) is another MLO mode in which an MLD may simultaneously transmit or receive traffic to or from another MLD via multiple communication links in parallel such that utilization of available resources may be increased to achieve higher throughput. That is, during at least some duration of time, transmissions or portions of transmissions may occur over two or more communication links in parallel at the same time. In some examples, the parallel communication links may support synchronized transmissions. In some other examples, or during some other durations of time, transmissions over the communication links may be parallel, but not be synchronized or concurrent. Additionally, in some examples or durations of time, two or more of the communication links may be used for communications between MLDs in the same direction (such as all uplink or all downlink), while in some other examples or durations of time, two or more of the communication links may be used for communications in different directions (for example, one or more communication links may support uplink communications and one or more communication links may support downlink communications). In such examples, at least one of the MLDs may operate in a full duplex mode.

MLA may be packet-based or flow-based. For packet-based aggregation, frames of a single traffic flow (such as all traffic associated with a given traffic identifier (TID)) may be transmitted concurrently across multiple communication links. For flow-based aggregation, each traffic flow (such as all traffic associated with a given TID) may be transmitted using a single respective one of multiple communication links. As an example, a single STA MLD may access a web browser while streaming a video in parallel. Per the above example, the traffic associated with the web browser access may be communicated over a first communication link while the traffic associated with the video stream may be communicated over a second communication link in parallel (such that at least some of the data may be transmitted on the first channel concurrently with data transmitted on the second channel). In some other examples, MLA may be implemented with a hybrid of flow-based and packet-based aggregation. For example, an MLD may employ flow-based aggregation in situations in which multiple traffic flows are created and may employ packet-based aggregation in other situations. Switching among the MLA techniques or modes may additionally, or alternatively, be associated with other metrics (such as a time of day, traffic load within the network, or battery power for a wireless communication device, among other factors or considerations).

Other MLO techniques may be associated with traffic steering and QoS characterization, which may achieve latency reduction and other QoS enhancements by mapping traffic flows having different latency or other requirements to different links. For example, traffic with low latency requirements may be mapped to communication links operating in the 6 GHz band and more latency-tolerant flows may be mapped to communication links operating in the 2.4 GHz or 5 GHz bands. Such an operation, referred to as TID-to-Link mapping (TTLM), may enable two MLDs to negotiate mapping of certain traffic flows in the downlink (DL) direction or the uplink (UL) direction or both directions to one or more set of communication links set up between them. In some examples, an AP MLD may advertise a global TTLM that applies to all associated non-AP MLDs. A communication link that has no TIDs mapped to it in either direction is referred to as a disabled link. An enabled link has at least one TID mapped to it in at least one direction.

In some examples, an MLD may include multiple radios and each communication link associated with the MLD may be associated with a respective radio of the MLD. Each radio may include one or more of its own transmit/receive (Tx/Rx) chains, include or be coupled with one or more of its own physical antennas or shared antennas, and include signal processing components, among other components. An MLD with multiple radios that may be used concurrently for MLO may be referred to as a multi-link multi-radio (MLMR) MLD. Some MLMR MLDs may further be capable of an enhanced MLMR (eMLMR) mode of operation, in which the MLD may be capable of dynamically switching radio resources (such as antennas or RF frontends) between multiple communication links (for example, switching from using radio resources for one communication link to using the radio resources for another communication link) to enable higher transmission and reception using higher capacity on a given communication link. In this eMLMR mode of operation, MLDs may be able to move Tx/Rx radio resources from one communication link to another link, thereby increasing the spatial stream capability of the other communication link. For example, if a non-AP MLD includes four or more STAs, the STAs associated with the eMLMR links may “pool” their antennas so that each of the STAs can utilize the antennas of other STAs when transmitting or receiving on one of the eMLMR links.

Other MLDs may have more limited capabilities and not include multiple radios. An MLD with only a single radio that is shared for multiple communication links may be referred to as a multi-link single radio (MLSR) MLD. Control frames may be exchanged between MLDs before initiating data or management frame exchanges between the MLDs in cases in which at least one of the MLDs is operating as an MLSR MLD. Because an MLD operating in the MLSR mode is limited to a single radio, it cannot use multiple communication links simultaneously and may instead listen to (for example, monitor), transmit or receive on only a single communication link at any given time. An MLSR MLD may instead switch between different bands in a time division multiplexed (TDM) manner. In contrast, some MLSR MLDs may further be capable of an enhanced MLSR (eMLSR) mode of operation, in which the MLD can concurrently listen on multiple links for specific types of packets, such as buffer status report poll (BSRP) frames or MU request-to-send (RTS) (MU-RTS) frames. Although an MLD operating in the eMLSR mode can still transmit or receive on only one of the links at any given time, it may be able to dynamically switch between bands, resulting in improvements in both latency and throughput. For example, when the STAs of a non-AP MLD may detect a BSRP frame on their respective communication links, the non-AP MLD may tune all of its antennas to the communication link on which the BSRP frame is detected. By contrast, a non-AP MLD operating in the MLSR mode can only listen to, and transmit or receive on, one communication link at any given time.

An MLD that is capable of simultaneous transmission and reception on multiple communication links may be referred to as a simultaneous transmission and reception (STR) device. In a STR-capable MLD, a radio associated with a communication link can independently transmit or receive frames on that communication link without interfering with, or without being interfered with by, the operation of another radio associated with another communication link of the MLD. For example, an MLD with a suitable filter may simultaneously transmit on a 2.4 GHz band and receive on a 5 GHz band, or vice versa, or simultaneously transmit on the 5 GHz band and receive on the 6 GHz band, or vice versa, and as such, be considered a STR device for the respective paired communication links. Such an STR-capable MLD may generally be an AP MLD or a higher-end STA MLD having a higher performance filter. An MLD that is not capable of simultaneous transmission and reception on multiple communication links may be referred to as a non-STR (NSTR) device. A radio associated with a given communication link in an NSTR device may experience interference when there is a transmission on another communication link of the NSTR device. For example, an MLD with a standard filter may not be able to simultaneously transmit on a 5 GHz band and receive on a 6 GHz band, or vice versa, and as such, may be considered a NSTR device for those two communication links.

In some wireless communication systems, an MLD may include multiple non-collocated entities. For example, an AP MLD may include non-collocated AP devices and a STA MLD may include non-collocated STA devices. In examples in which an AP MLD includes multiple non-collocated AP devices, an SMD entity may refer to a logical entity that controls the associated non-collocated APs. A non-AP STA (such as a non-MLD non-AP STA or a non-AP MLD that includes one or more associated non-AP STAs) may associate with the SMD entity via one of its constituent APs and may seamlessly roam (such as without requiring reassociation) between the APs associated with the SMD entity. The SMD entity also may maintain other context (such as security and Block acknowledgement (ACK)) for non-AP STAs associated with it.

The afore-mentioned and related MLO techniques may provide multiple benefits to a wireless communication network 100. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the “on” time of a modem, which may benefit a wireless communication device in terms of power consumption. Another benefit of MLO is the increased multiplexing opportunities in the case of a single BSS. For example, MLA may increase the number of users per multiplexed transmission served by the multi-link AP MLD.

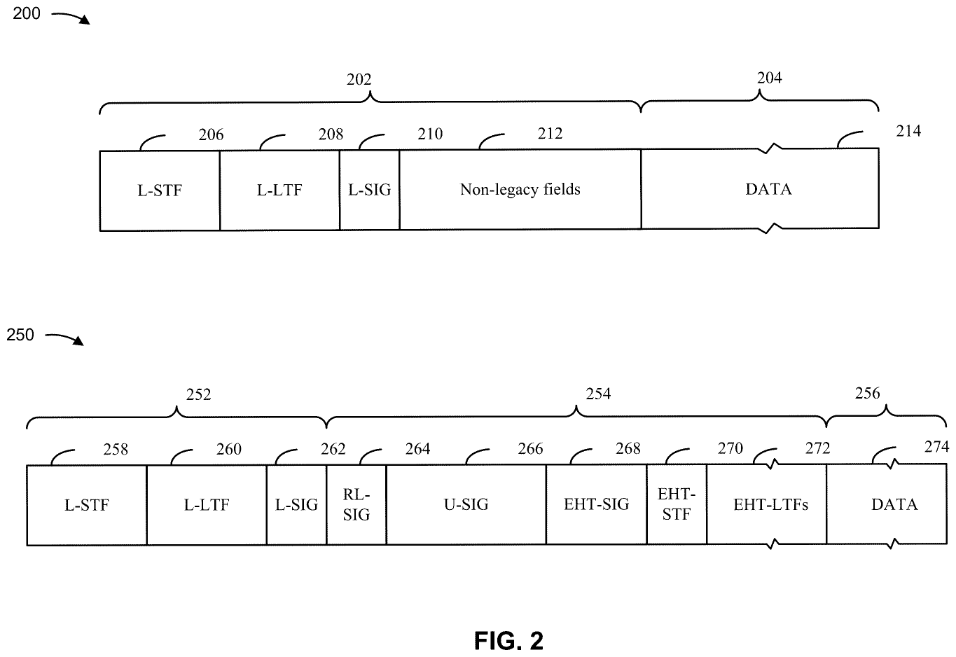

FIG. 2 shows an example protocol data unit (PDU) 200 usable for wireless communication between a wireless AP and one or more wireless STAs. For example, the AP and STAs may be examples of the AP 102 and the STAs 104 described with reference to FIG. 1. The PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device (such as an AP 102 or a STA 104) to perform coarse timing and frequency tracking and automatic gain control (AGC). The L-LTF 208 generally enables the receiving device to perform fine timing and frequency tracking and also to perform an initial estimate of the wireless channel. The L-SIG 210 generally enables the receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

FIG. 2 also shows an example PHY protocol data unit (PPDU) 250 usable for communications between a wireless AP and one or more wireless STAs. For example, the AP and STAs may be examples of the AP 102 and the STAs 104 described with reference to FIG. 1. As shown, the PPDU 250 includes a PHY preamble, that includes a legacy portion 252 and a non-legacy portion 254, and a payload 256 that includes a data field 274. The legacy portion 252 of the preamble includes an L-STF 258, an L-LTF 260, and an L-SIG 262. The non-legacy portion 254 of the preamble includes a repetition of L-SIG (RL-SIG) 264 and multiple wireless communication protocol version-dependent signal fields after RL-SIG 264. For example, the non-legacy portion 254 may include a universal signal field 266 (referred to herein as “U-SIG 266”) and an extremely high throughput (EHT) signal field 268 (referred to herein as “EHT-SIG 268”). The presence of RL-SIG 264 and U-SIG 266 may indicate to EHT- or later version-compliant STAs 104 that the PPDU 250 is an EHT PPDU or a PPDU conforming to any later (post-EHT) version of a new wireless communication protocol conforming to a future IEEE 802.11 wireless communication protocol standard. One or both of U-SIG 266 and EHT-SIG 268 may be structured as, and carry version-dependent information for, other wireless communication protocol versions associated with amendments to the IEEE family of standards beyond EHT. For example, U-SIG 266 may be used by a receiving device (such as an AP 102 or a STA 104) to interpret bits in one or more of EHT-SIG 268 or the data field 274. Like L-STF 258, L-LTF 260, and L-SIG 262, the information in U-SIG 266 and EHT-SIG 268 may be duplicated and transmitted in each of the component 20 MHz channels in instances involving the use of a bonded channel.

The non-legacy portion 254 further includes an additional short training field 270 (referred to herein as “EHT-STF 270,” although it may be structured as, and carry version-dependent information for, other wireless communication protocol versions beyond EHT) and one or more additional long training fields 272 (referred to herein as “EHT-LTFs 272,” although they may be structured as, and carry version-dependent information for, other wireless communication protocol versions beyond EHT). EHT-STF 270 may be used for timing and frequency tracking and AGC, and EHT-LTF 272 may be used for more refined channel estimation.

EHT-SIG 268 may be used by an AP 102 to identify and inform one or multiple STAs 104 that the AP 102 has scheduled UL or DL resources for them. EHT-SIG 268 may be decoded by each compatible STA 104 served by the AP 102. EHT-SIG 268 may generally be used by the receiving device to interpret bits in the data field 274. For example, EHT-SIG 268 may include resource unit (RU) allocation information, spatial stream configuration information, and per-user (for example, STA-specific) signaling information. Each EHT-SIG 268 may include a common field and at least one user-specific field. In the context of OFDMA, the common field can indicate RU distributions to multiple STAs 104, indicate the RU assignments in the frequency domain, indicate which RUs are allocated for MU-MIMO transmissions and which RUs correspond to OFDMA transmissions, and the number of users in allocations, among other examples. The user-specific fields are assigned to particular STAs 104 and carry STA-specific scheduling information such as user-specific modulation and coding scheme (MCS) values and user-specific RU allocation information. Such information enables the respective STAs 104 to identify and decode corresponding RUs in the associated data field 274.

Seamless roaming for a wireless device or client (non-AP MLD) may include roaming (transition to be served) from a current AP MLD to a target AP MLD. An SMD may be defined for seamless roaming, such that AP MLDs within the same SMD can obtain a higher level of coordination for the client service transition to be as smooth as possible. The SMD may preserve the context necessary for resuming communications after the transition (i.e., avoiding re-association, re-authentication, re-negotiation of agreements such as a target wake time (TWT)). The SMD may minimize the interruption of service. It is assumed that during a transition, the client has to interrupt the uplink so as to not confuse the distribution system (DS). In fact, at the core of roaming there is the update of the DS mapping for the client, to set which AP MLD the DS should send data to for delivery to the client. If all the operations like context transfer and links setup are performed during one phase, the suspension of transmissions may be too long and may introduce latency.

As indicated above, FIG. 2 is provided as an example. Other examples may differ from what is described with regard to FIG. 2.

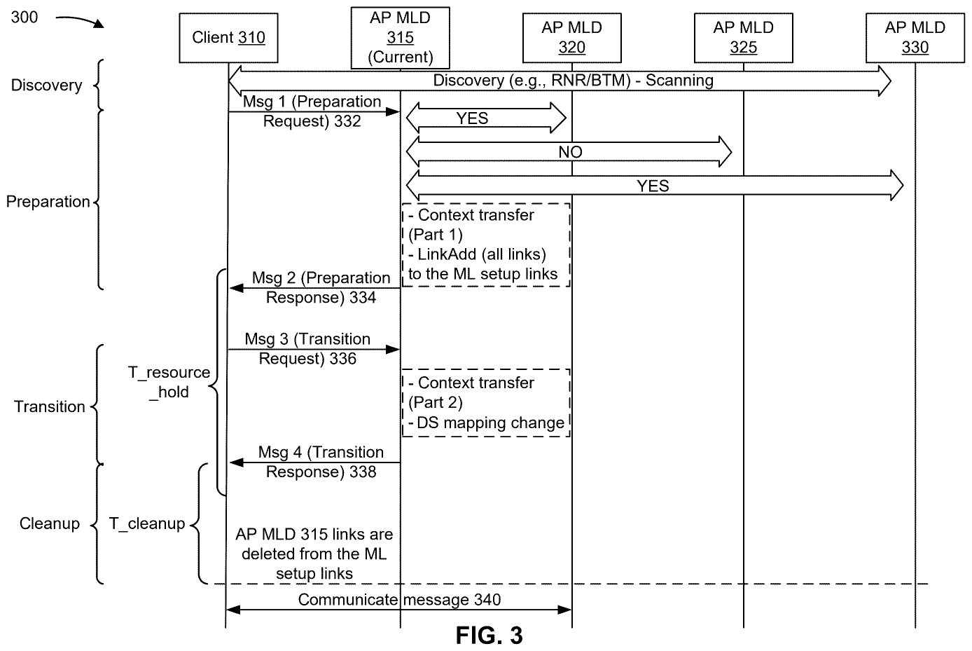

FIG. 3 is a diagram illustrating an example 300 of seamless roaming.

According to various aspects described herein, a wireless device (client, non-AP MLD) and AP MLDs may exchange messages such that the client can seamlessly roam from a current AP MLD to a target AP MLD. The seamless roaming may involve different phases. In phase 1, most of the burden of the roaming setup is taken care of without service interruptions. In phase 2, the transition is consolidated (e.g., DS mapping change) and fast as possible for minimal overall service interruption. A four message handshake may perform the seamless roaming between two AP MLDs within the same SMD. The handshake may include roaming preparation (Phase 1, Msg1 and Msg2), the transition (Phase 2, Msg3 and Msg4), and a cleanup (Phase 3).

Example 300 shows a sequence of the four messages. The preparation phase may follow a discovery phase, where the client may gather information for some AP MLDs within the SMD (e.g., active/passive scanning, radio network reselection (RNR), beacon timing and measurement (BTM), etc.). In the preparation phase, the Msg1 may include a first request (preparation request) 332 from the client 310 to the current AP MLD 315. The first request may request the AP MLD 315 to prepare at least one candidate AP MLD. The AP MLD 315 and each of the candidate AP MLDs respectively include one or more associated APs that are operating on a link of its respective AP MLD. The preparation may include the AP MLD 315 coordinating with the candidate AP MLDs (within the same SMD) to select one or more first candidate AP MLDs that can be prepared. In example 300, AP MLD 320, AP MLD 325, and AP MLD 330 are candidate AP MLDs, but only AP MLD 320 and AP MLD 330 can be prepared as a set of first candidate AP MLDs. One of these AP MLDs may be prepared.

In some aspects, the preparation phase may include link additions to consolidate the candidate AP MLDs'preparation, applying a TTLM, and/or providing a new simplified report for three tiers of APs (e.g., different AP MLD or combination of AP MLDs for each tier) as an outcome of the preparation. The preparation may include performing link additions (to multi-link (ML) setup links of the client 310) of links for each of the first candidate AP MLDs. The request is implicit for all the links of the AP MLDs. The Msg1 may indicate the bands of interest of the client 310, so that the corresponding links of the AP MLDs are added. For example, the client 310 may indicate a 2.4 GHz and 5 GHz, and the network may perform link addition for the links of the candidate AP MLDs corresponding to those bands. The Msg1 may explicitly indicate (e.g., with per-client profiles) which indexed link(s) of any explicitly requested candidate AP MLD are expected to be added in the case that such AP MLD is prepared by the network. Modification of the first candidate AP MLD set may be performed by iterating the preparation phase again.

In some aspects, the Msg1 may request a TTLM for the added links (all TIDs to all links). The Msg1 may provide an explicit indication (e.g., one bit) on whether the default TTLM is to be adopted. The indication may indicate a link for which default TTLM is adopted, and if the link is in an enabled state but in power save (doze).

In some aspects, the client 310 may include a ranking (e.g., ordered short list) of AP MLDs by the client 310, starting with a most preferred AP MLD and so on. The ranking may include respective sub-element values or positions for the AP MLDs. The Msg1 may include a set of sub-elements (one for each AP MLD) where to each AP MLD is assigned a value (indicated in the sub-element) to provide the client 310 level of preference. In some aspects, the BTM framework may be used to indicate AP MLDs and their level of preference by assigning a value within a range to each AP MLD. The Msg1 may include a set of sub-elements (one for each AP MLD) where the position of a sub-element relative to the others implicitly indicates the client level of preference. In some aspects, the ML reconfiguration framework may be enhanced to allow inclusion multiple elements or sub-elements, one per each AP MLD, where the order of inclusion indicates the level of preference of any given AP MLD. The AP MLD 315 may use the ranking to select a first set of candidate AP MLDs among one or more candidate AP MLDs. The Msg1 may also indicate whether only the AP MLDs in the ranking are to be considered for selection as the target AP MLD or whether additional candidate AP MLDs are to be considered for the selection.

In an example, the AP MLD 315 may first satisfy the ranking provided by the client 310. If the AP MLD 315 is to add links for only one AP MLD, the links may be for the highest AP MLD on the ranking or shortlist that also matches the network-side criteria. The AP MLD 315 may check over the backhaul to inquire whether such an AP MLD is able to serve the client 310. In some aspects, an AP MLD is able to serve a client based on several factors including the number of associated clients, the load in the BSS, and/or the number of affiliated APs. In some aspects, an AP MLD is able to serve a client if the AP MLD is able to accept the transfer of the context for communications (e.g., the agreements, including but not restricted to block acknowledgement (BA) agreements, subcarrier spacing (SCS) agreements, TWT agreements, etc.). If the AP MLD 315 determines that N AP MLDs can be prepared, the AP MLD 315 may first satisfy the ranking or shortlist provided by the client 310 in the Msg1 and then extend to more AP MLDs if requested by the client 310.

In some aspects, the Msg1 may indicate (e.g., toggling a one bit indication) whether or not network-side recommendations are be considered when determining the first candidate AP MLDs of prepared candidates. For example, the client 310 may have the bit set to “OFF”, and the client 310 may expect the network (e.g., AP MLD 315) to check and eventually prepare the preferred candidates. This case may be driven by the client 310 trying to minimize the latency due to network checks (e.g., checking preferred AP MLDs). In another example, the client 310 may have the bit set to “ON”, and the client 310 may expect the network to check more AP MLDs that the client 310 may even not be aware of. In some aspects, the client 310 may provide no preferences (e.g., no ranking or shortlist), and the client 310 may thus rely on the network to provide suitable candidates.

The Msg2 may include a first response (preparation response) 334 from the AP MLD 315 to the client 310. The Msg2 may indicate the first candidate AP MLD set. The AP MLD 315 may perform a context transfer (a first part) with the first candidate AP MLDs. In example, only the AP MLD 320 is prepared with a context transfer. The first part of the context transfer may include only necessary context, which may include a security context (e.g., pairwise master key (PMK), pairwise transient key (PTK)), a block acknowledgement (BA), an SCS, or a TWT value. The AP MLD 315 may perform an ML reconfiguration link add for the AP MLD 320 (or for other first candidate AP MLDs).

In some aspects, the Msg2 may include a report list that indicates a tier. Tier 3 may include the (set of) AP MLD(s) that are prepared (e.g., links are added to the ML setup links, part 1 of context is transferred). Tier 2 may include the (set of) AP MLD(s) that are not prepared, but can accept the client 310 (according to the network-side checks performed over the backhaul). Tier 1 may include the (set of) AP MLD(s) that cannot accept the client 310 (according to the network-side checks performed over the backhaul). Only AP MLDs from the shortlist in Msg1 are categorized if a network-side recommendation is not enabled.

In the transition phase, the Msg3 may include a second request (transition request) 336. The second request may request that the AP MLD 315 transition service of the client 310 from the AP MLD 315 to the target AP MLD, such as AP MLD 320. In some aspects, the transition phase may involve a new container (e.g., TTLM frame) and enabling/disabling as well as awaking/dozing links of the current AP MLD 315 and the target AP MLD (from among one or more candidate AP MLDs). The transition phase may also include indications for a desired handling of a pending DL service, validation of a transition request message at the target AP MLD, and/or a quicker transition completion that is not based on receiving a Msg4. The AP MLD 315 may perform another context transfer (second part) and initiate a DS mapping change with the AP MLD 320. The Msg4 of the transition phase may include a transition response 338, which indicates completion of the transition.

The client 310, after receiving the Msg2, has information as to which AP MLD(s) are prepared. The expectation is that if the Msg3 is sent within a timeout duration, the transition request (Msg3) may be accepted (with a probability of one). If the client 310 sends the transition request (Msg3) for a transition to a tier 3 AP MLD within a timeout duration (e.g., T_resource_hold), the transition request may be accepted and such a result may be conveyed in the Msg4.

In the cleanup phase, the client 310 may stop communicating with the current AP MLD based at least in part on the end of a transitory period for the completion of the transition. In some aspects, a new cleanup scheme in the cleanup phase may involve the termination of communications with the AP MLD 315 after the transition phase is concluded. The AP MLD 315 may delete links from the ML setup links. There may be a time duration (e.g., T_cleanup) for the cleanup phase. The client 310 may start communicating based on the Msg4. The client 310 may communicate (transmit or receive) a message 340 to or from the target AP MLD (AP MLD 320).

In some aspects, the Msg3 may be included in a TTLM request frame. With this frame, the client 310 may disable some links of the AP MLD 315, and/or assign TIDs to specific links of the AP MLD 315 that the client 310 expects to maintain for some time, with the understanding that the corresponding links (to those that are disabled) of the AP MLD 320 may enter an awake state (e.g. baseline, with message subsequent to Msg4) on the links set to awake including a packet mode (PM)=0 indication in the MAC header. Signaling may be added for enhanced TTLMs.

In some aspects, the Msg 3 may be included in an ML reconfiguration request frame. With this frame, the client 310 may maintain a stronger stance on the links of the AP MLD 315, which are subject to an ML reconfiguration link delete operation. The operation may be less reversible in case the client 310 wants to return to the AP MLD 315, in which case the link addition may take place in full, as opposed to just enabling such links with a TTLM. In some aspects, the Msg3 may be included in a new frame that is dedicated for Msg3 and related content.

In some scenarios, a link can be set to a doze or awake state by toggling a bit (PM state 1/0) in the MAC header of a frame transmitted on such a link for which the PM state is to be toggled. PM toggling may be used for multiple links of the AP MLD that is receiving the frame. Further, a cross-MLD PM indication may include a frame sent over a link of an AP MLD and may signal toggling the PM state of another link of another AP MLD. In some aspects, the Msg3 may include an indication to doze one or more links of the AP MLD 315 or an indication to awake one or more links of the AP MLD 320. The operations on the network side may be sequential, such that there are no concurrent awake (corresponding, e.g., on the same band) links from different AP MLDs. In some cases, cross-link is allowed. In other cases, both cross-link and cross-MLD are allowed.

As indicated above, FIG. 3 is provided as an example. Other examples may differ from what is described with regard to FIG. 3.

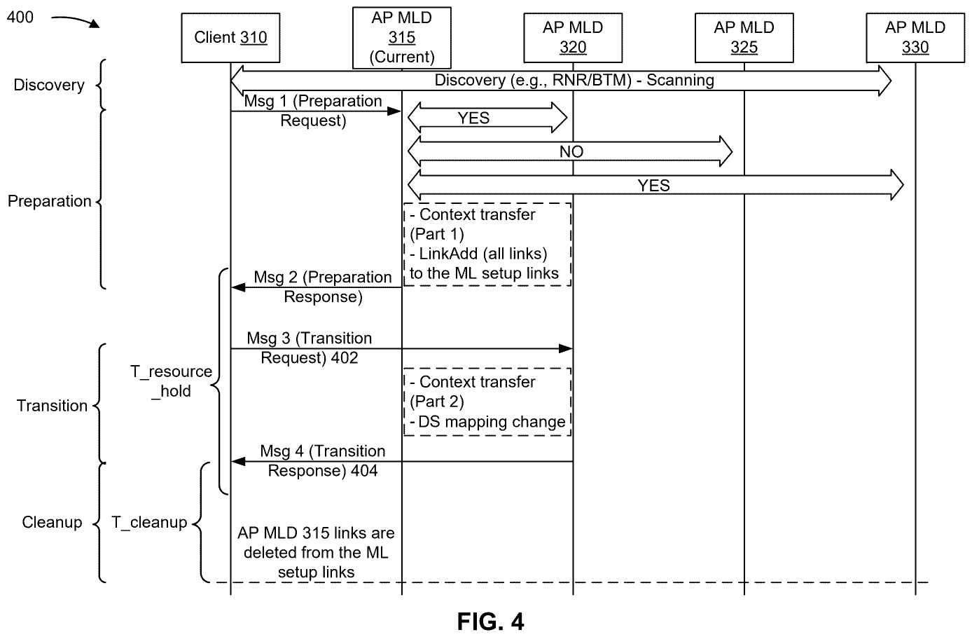

FIG. 4 is a diagram illustrating an example 400 of a sequence of messages. In example 300, the client 310 may transmit Msg3 to the AP MLD 315. In example 400, the client 310 may transmit a Msg3 402 to the target AP MLD, such as AP MLD 320. The AP MLD 320 may be the tier 3 AP MLD, or one of the tier 3 AP MLDs depending on allowing or not allowing multiple prepared candidates. The Msg3 may be an encrypted frame. Accordingly, AP MLD 320 may transmit Msg4 404 to the client 310.

In some aspects, the Msg3 may include an indication of how the client 310 expects the pending downlink at the AP MLD 315 to be handled. The indication may indicate that the pending DL is to be discarded, forwarded to AP MLD 320 (e.g., will be retrieved from the AP MLD 320 after the transition is completed), or drained from the AP MLD 315. There may be a time after the Msg4 during which the AP MLD 315 can still send the DL to the client 310.

If the Msg3 is transmitted to the AP MLD 320, the Msg3 may be validated. The Msg3 may be encrypted and then decrypted using the PTK security association (PTKSA) that was provided in the first part of the context transfer (preparation). The sequence number (SN) and the preamble number (PN) of the Msg3 is expected to be valid. During the preparation (between Msg1 and Msg2), as part of the context transfer, a target SN and PN are to be provided to the candidate(s) AP MLD(s) that are prepared. The AP MLD 315 may determine a large enough SN*/PN* such that it is unlikely that, before the Msg3 is sent, a SN*/PN* may be used in communications between the client 310 and the AP MLD 315. The AP MLD 320 may consider the Msg3 to be valid if the SN/PN of the Msg3 are larger than the SN*/PN*. In some aspects, the AP MLD 320 may receive the Msg3 and retrieve the latest SN/PN from the AP MLD 315 over the backhaul, so as to validate the Msg3. The AP MLD 320 may consider the Msg3 to be valid if the SN/PN of the Msg3 are larger than the retrieved SN/PN.

In some aspects, the AP MLD 320 may accept any SN/PN but validate the Msg3 by a transaction token. A time synchronization function (TSF) may be added to the encrypted Msg3 (e.g., the AP MLD 320 may validate the time stamp being current, or within some margin to the current TSF). In some aspects, a separate SN/PN may be used for roaming (e.g., SNr/PNr). The SNr/PNr may be provided in the first part of the context transfer between Msg1 and Msg2, such that the first update of the numbers may be for the Msg3 to the AP MLD 320 (target AP MLD can validate). In some aspects, the AP MLD 315 may generate a random secret key or token and provide the secret key or token to both candidate(s) AP MLD(s) during preparation, and to the client 310 (in Msg2). The client 310 may add a token in the encrypted Msg3 for the AP MLD 320 to validate. The token may have a validity time (e.g., T_resource_hold after Msg2).

The Msg3 and Msg4 handshake can be performed between the client 310 and either the AP MLD 315 or the AP MLD 320. The AP MLD 315 or the AP MLD 320 may transmit Msg4 to the client 310 to notify that the DS mapping has been updated, and the context is completely transferred, which means that the AP MLD 315 is ready for data communications with the client 310. The overall constraint is that before awakening a link of the AP MLD 320, the corresponding link (same band) of the AP MLD 315 may be in a doze state. Depending on the already performed operations for enabling/awakening the new links (of the AP MLD 320), and disabling/dozing the old links (of the AP MLD 315), the client 310 may need to perform further operations to start data transmission/reception on the new links. For example, the default TTLM for a target after the Msg2 may disable some links of the AP MLD 320 in the Msg3 and awake links of the AP MLD 320 after the Msg4 with, for example, a QoS null frame with a PM=0 indication in a MAC header on the desired link to be awakened.

There may be pending DL transmission from the AP MLD 315 to the client 310 for some time after the Msg4. At some point, the transition may be completed by deleting links (of the AP MLD 315) from the ML setup links. If links are not deleted yet, the operation of the ML reconfiguration request to delete links is performed in one of several ways. In a timeout based-baseline example, upon reaching a maximum timeout, both the client 310 and the AP MLD 315 may perform the ML reconfiguration link delete operation independently (no need for an over-the-air (OTA) exchange), to delete all of the links related to the client-AP MLD pair. In a client-initiated example, the client 310 may always transmit an ML reconfiguration request to delete the links (of either the AP MLD 315 or the AP MLD 320). The request may be forwarded over the backhaul. In a network-initiated example, upon meeting a condition (e.g., completion of pending DL draining from the AP MLD 315), the AP MLD 315/AP MLD 320 may transmit a ML reconfiguration recommendation to the client 310 to signal that the pending DL is completed. The client 310 may then perform an explicit request as in the client-initiated example, or let the timeout timer expire as in the timeout-based example. For the recommendation, alternatively, the AP MLD 315 may coordinate over the backhaul so that the AP MLD 320 may transmit the ML reconfiguration recommendation to the client 310.

As indicated above, FIG. 4 is provided as an example. Other examples may differ from what is described with regard to FIG. 4.

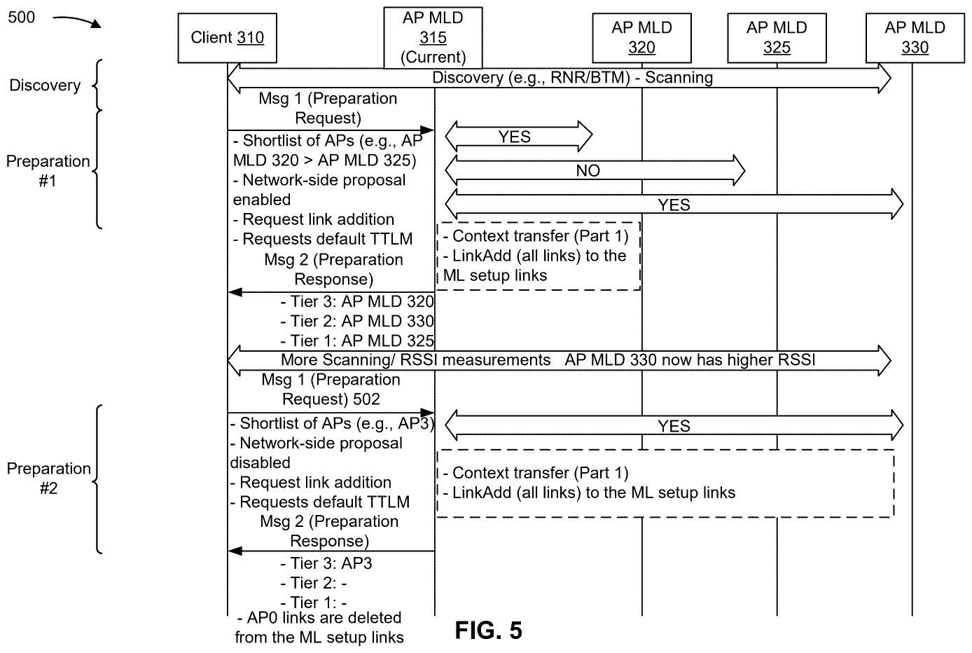

FIG. 5 is a diagram illustrating an example 500 of another preparation phase iteration.

In some aspects, the tiers of AP MLDs may be reshaped. For example, AP MLD 320 may be preferred over AP MLD 325 in a shortlist. Tier 3 may include AP MLD 320, tier 2 may include AP MLD 330, and tier 1 may include AP MLD 325. With a new iteration of preparation, some AP MLDs from tier 2 may go into tier 3. More scanning or RSSI measurements may reveal that AP MLD 330 may have a higher RSSI and is to be moved from tier 2 to tier 3. The client 310 may request a transition via Msg3 502 to transition to a tier 3 AP MLD, which is now AP MLD 330. Context transfer and link addition may be performed for AP MLD 330. Otherwise, the client 310 may perform another iteration of preparation (Msg1 and Msg2) to modify the set of tier 3 APs. For example, the client 310 may provide a ranking or shortlist in Msg1, where the top-of-the list is the desired AP MLD that was placed in tier 2 in the previous iteration. The client 310 may also disable the network-side recommendation and not add other AP MLDs in the shortlist to minimize the delay to Msg2 and the latency due to further network-side operations.

In some aspects, the AP MLD 315 may rank the AP MLDs belonging to different tiers in a report to provide to the client 310 the network-side preference. For example, the Msg2 may include a set of sub-elements (one for each AP MLD) where to each AP MLD is assigned a value (indicated in the sub-element) to provide the client 310 a level of preference. There may be a range for each tier (e.g. 0 -80 for tier 1, 81-200 for tier 2, and 101-255 for tier 3), and within each range the AP MLDs may be assigned a value representative of the network preference. This report may be enabled using a BTM response as a container. In another example, the Msg1 may include a set of sub-elements (one for each AP MLD), where the position of a sub-element relative to the others implicitly indicates the client 310 level of preference. For each AP MLD (e.g. in each sub-element), there may be a field to indicate whether the AP MLD is tier 3, tier 2, or tier 1. The report may be enabled using an ML reconfiguration response as a container.

As indicated above, FIG. 5 is provided as an example. Other examples may differ from what is described with regard to FIG. 5.

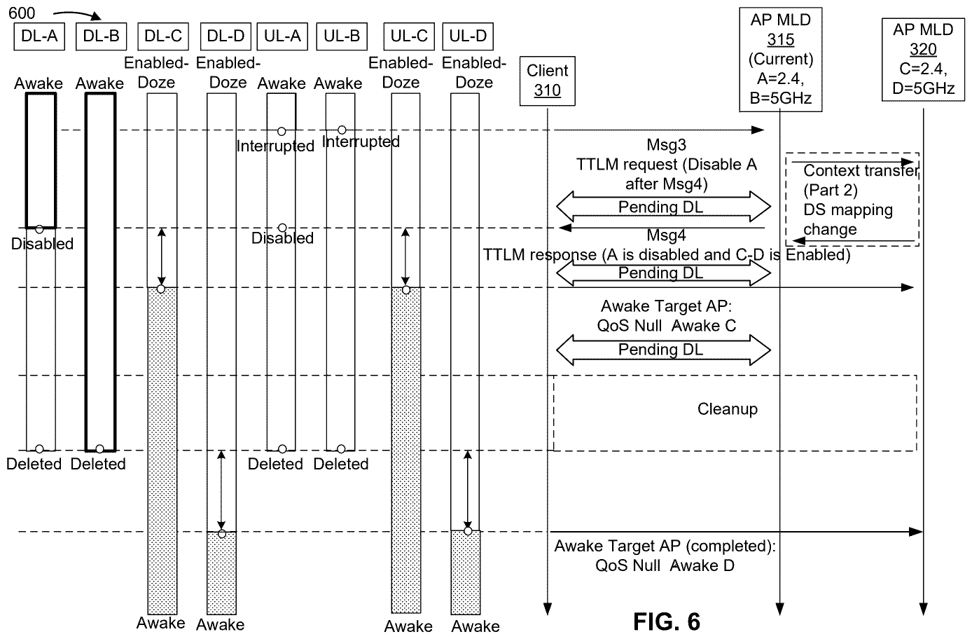

FIG. 6 is a diagram illustrating an example 600 of DL link operations with a default TTLM.

While in some scenarios, the client 310 may start communicating with the target AP MLD (e.g., AP MLD 320) based on receiving the Msg4, in some aspects, such communications may start prior to reception of the Msg4. For example, for a DL, the AP MLD 320 may start transmitting on the DL if the transition has been finalized, the context is fully transferred, and the DS mapping change has been reported. The AP MLD 320 may have some data to transmit, which can occur if the AP MLD 315 starts receiving a new DL from the DS. The AP MLD 315 may have already forwarded some pending DL to the AP MLD 320. The new DL, with the proper TTLM (enabled), has been awakened and the corresponding DL of the AP MLD 315 has been dozed or disabled. In some aspects, communications with the AP MLD 320 may start upon receiving a DL from the AP MLD 320, which is subject to the conditions described above. The Msg3 to the AP MLD 320 may be included in the TTLM to reshuffle the TIDs on the AP MLD 315's links, and a cross-AP power save indication (to awake the target AP MLD's links). In another example, the AP MLD 315's link(s) may be dozed with a QoS null message with PM=1 beforehand, Then, the client 310 may transmit the Msg3 to the AP MLD 320 with PM=0 to awake the AP MLD 320's links.

Example 600 shows DL links with a default TTLM in the preparation phase. DL-A and DL-B for AP MLD 315 may be pending DL links. The Msg3 may request that DL-A is disabled. The Msg4 may indicate that DL-A is disabled and that DL-C and DL-D are enabled. The DL-C may be set to awake.

In some aspects, the AP MLD 315 may have already received, from the DS, downlink traffic for the client 310. The AP MLD 315 may transmit this pending DL to the client 310 during the roaming. The client 310 may indicate whether the client 310 is interested in the reception of the pending DL, whether the client 310 is to request the AP MLD 315 to forward the pending DL to the AP MLD 320, or whether the client 310 is to indicate that the pending DL can be discarded and its transmission/reception can be avoided.

As indicated above, FIG. 6 is provided as an example. Other examples may differ from what is described with regard to FIG. 6.

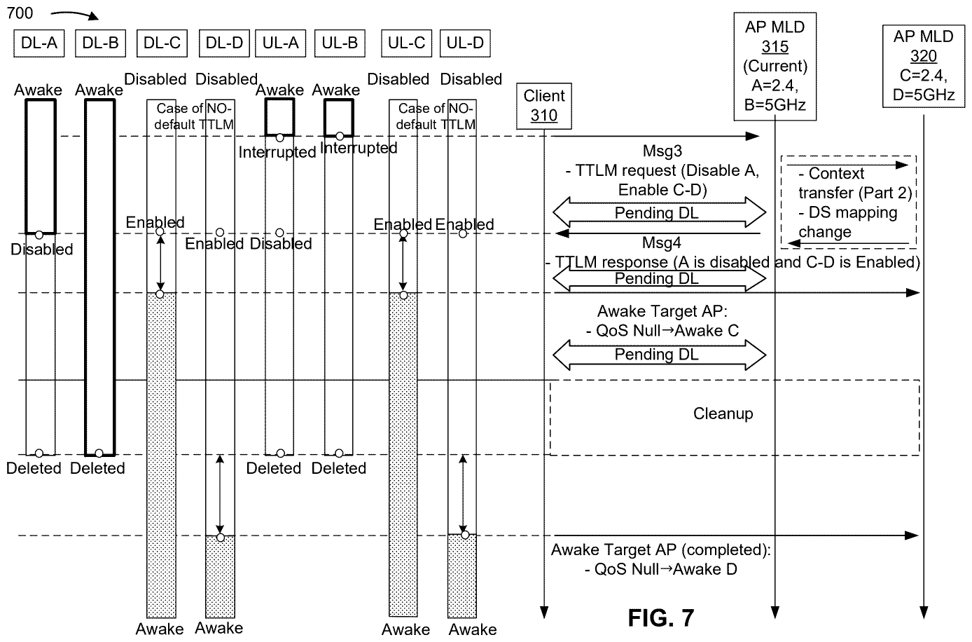

FIG. 7 is a diagram illustrating an example 700 of DL link operations without a default TTLM.

Example 700 shows DL links without a default TTLM in the preparation phase. DL-A and DL-B for AP MLD 315 may be pending DL links. The Msg3 may request that DL-A is disabled. The Msg4 may indicate that DL-A is disabled and that DL-C and DL-D are enabled. The DL-C may be set to awake.

As indicated above, FIG. 7 is provided as an example. Other examples may differ from what is described with regard to FIG. 7.

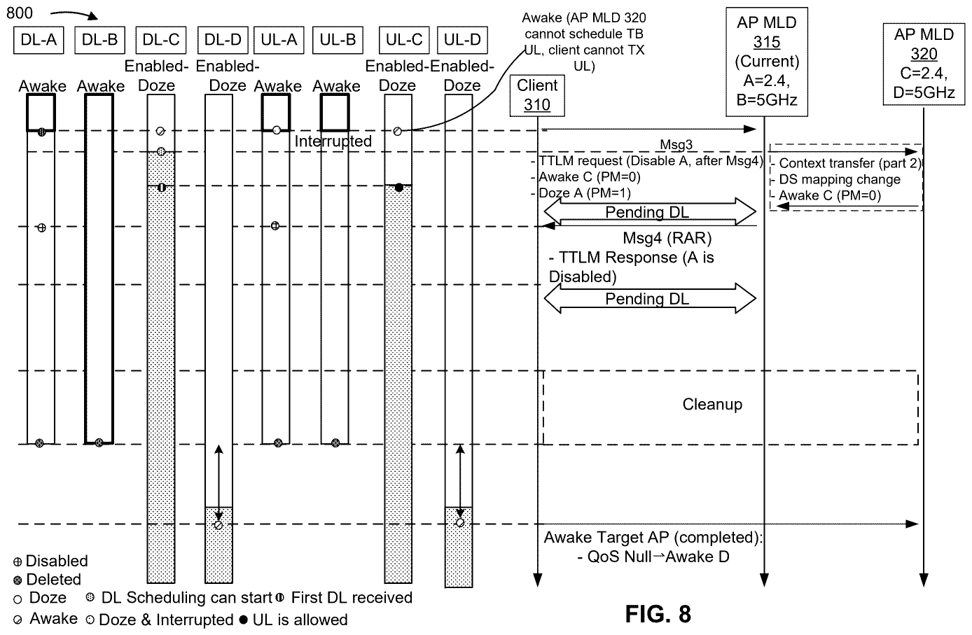

FIG. 8 is a diagram illustrating an example 800 of DL link operations with a default TTLM with cross-link and cross-AP indication.

In some aspects, to prevent issues of collisions between DL-A and DL-C, the Msg3 may indicate that all the TIDs mapped to DL-A will go to DL-B. Only after the TIDs are re-mapped to DL-B and DL-A is to doze, the AP MLD 315 may notify the AP MLD 320 to that DL-C can be placed in an awake state.

As indicated above, FIG. 8 is provided as an example. Other examples may differ from what is described with regard to FIG. 8.

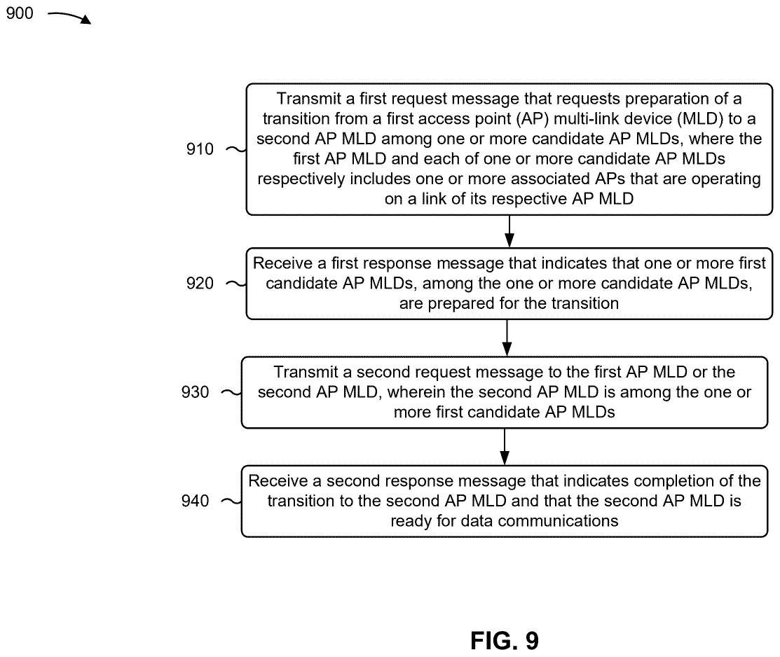

FIG. 9 is a diagram illustrating an example process 900 performed, for example, at a wireless device or an apparatus of a wireless device. Example process 900 is an example where the apparatus or the wireless device (e.g., client 310) performs operations associated with seamless roaming.

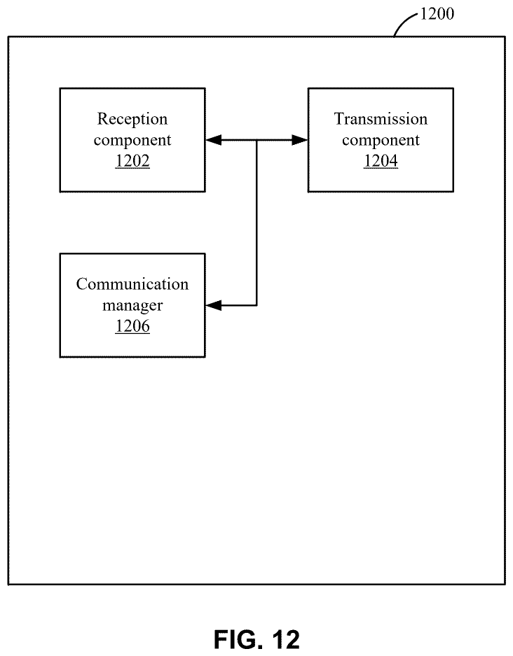

As shown in FIG. 9, in some aspects, process 900 may include transmitting a first request message that requests preparation of a service transition from a first AP MLD to a second AP MLD among one or more candidate AP MLDs, where the first AP MLD and each of one or more candidate AP MLDs respectively includes one or more associated APs that are operating on a link of its respective AP MLD (block 910). For example, the wireless device (e.g., using transmission component 1204 and/or communication manager 1206, depicted in FIG. 12) may transmit a first request message that requests preparation of a service transition from a first AP MLD to a second AP MLD among one or more candidate AP MLDs, where the first AP MLD and each of one or more candidate AP MLDs respectively includes one or more associated APs that are operating on a link of its respective AP MLD, as described above.

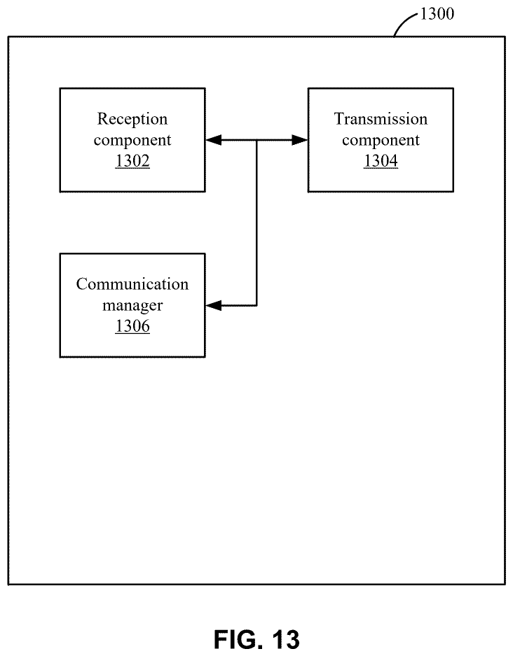

As further shown in FIG. 9, in some aspects, process 900 may include receiving a first response message that indicates that one or more first candidate AP MLDs, among the one or more candidate AP MLDs, are prepared for the service transition (block 920). For example, the wireless device (e.g., using reception component 1302 and/or communication manager 1306, depicted in FIG. 13) may receive a first response message that indicates that one or more first candidate AP MLDs, among the one or more candidate AP MLDs, are prepared for the service transition, as described above.

As further shown in FIG. 9, in some aspects, process 900 may include transmitting a second request message to the first AP MLD or the second AP MLD, where the second AP MLD is among the one or more first candidate AP MLDs (block 930). For example, the wireless device (e.g., using transmission component 1304 and/or communication manager 1306, depicted in FIG. 13) may transmit a second request message to the first AP MLD or the second AP MLD, where the second AP MLD is among the one or more first candidate AP MLDs, as described above.

As further shown in FIG. 9, in some aspects, process 900 may include receiving a second response message that indicates completion of the service transition to the second AP MLD and that the second AP MLD is ready for data communications (block 940). For example, the wireless device (e.g., using reception component 1302 and/or communication manager 1306, depicted in FIG. 13) may receive a second response message that indicates completion of the service transition to the second AP MLD and that the second AP MLD is ready for data communications, as described above.

Process 900 may include additional aspects, such as any single aspect or any combination of aspects described below and/or in connection with one or more other processes described elsewhere herein.

In a first aspect, the first request message includes a ranking of AP MLDs.

In a second aspect, alone or in combination with the first aspect, the ranking includes a set of sub-element values or positions for the AP MLDs.

In a third aspect, alone or in combination with one or more of the first and second aspects, the first request message indicates whether only AP MLDs from the ranking are to be considered for selection of the second AP MLD or whether additional candidate AP MLDs are to be considered for the selection.

In a fourth aspect, alone or in combination with one or more of the first through third aspects, process 900 includes communicating a message on a link of the second AP MLD after or in response to receiving the second response message.

In a fifth aspect, alone or in combination with one or more of the first through fourth aspects, the first request message is associated with all links of the one or more candidate AP MLDs.

In a sixth aspect, alone or in combination with one or more of the first through fifth aspects, the first request message indicates one or more bands of interest of the wireless device.

In a seventh aspect, alone or in combination with one or more of the first through sixth aspects, the first request message indicates a TTLM for added links of the second AP MLD.

In an eighth aspect, alone or in combination with one or more of the first through seventh aspects, the first request message indicates a first context transfer to the one or more first candidate AP MLDs, and the second request message indicates one or more of a second context transfer, a request for a mapping change, or a transition of service to the second AP MLD.

In a ninth aspect, alone or in combination with one or more of the first through eighth aspects, the first request message indicates how a pending downlink is to be handled.

In a tenth aspect, alone or in combination with one or more of the first through ninth aspects, the first request message uses a TTLM request frame, a link reconfiguration request frame, or a frame specific to transition preparation.

In an eleventh aspect, alone or in combination with one or more of the first through tenth aspects, the first request message indicates one or more of a set of links to wake or a set of links to cause to sleep.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

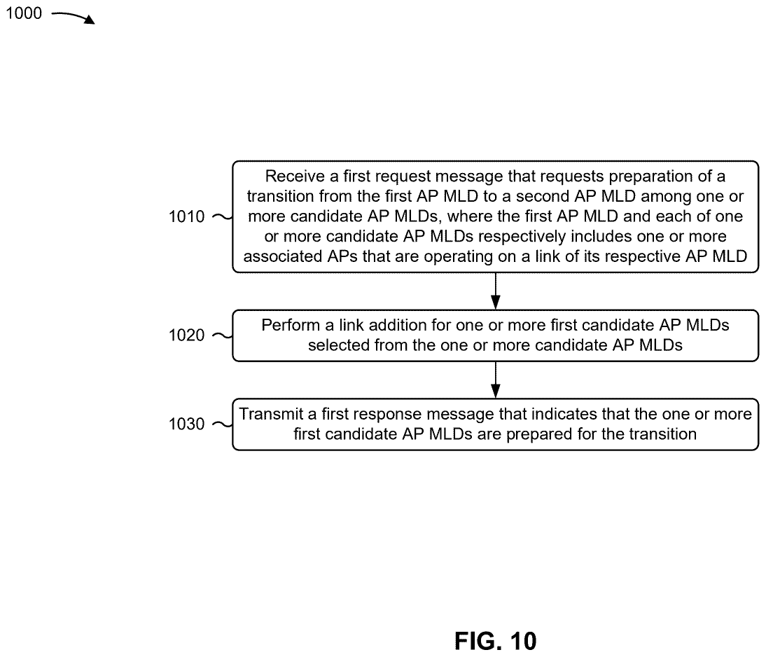

FIG. 10 is a diagram illustrating an example process 1000 performed, for example, at an AP or an apparatus of an AP. Example process 1000 is an example where the apparatus or the AP (e.g., AP MLD 315) performs operations associated with seamless roaming. In some examples, the process 1000 may be performed by a wireless AP such as one of the APs 102 described with reference to FIG. 1.

As shown in FIG. 10, in some aspects, process 1000 may include receiving a first request message that requests preparation of a service transition from the first AP MLD to a second AP MLD among one or more candidate AP MLDs, where the first AP MLD and each of one or more candidate AP MLDs respectively includes one or more associated APs that are operating on a link of its respective AP MLD (block 1010). For example, the AP (e.g., using reception component 1302 and/or communication manager 1306, depicted in FIG. 13) may receive a first request message that requests preparation of a service transition from the first AP MLD to a second AP MLD among one or more candidate AP MLDs, where the first AP MLD and each of one or more candidate AP MLDs respectively includes one or more associated APs that are operating on a link of its respective AP MLD, as described above.

As further shown in FIG. 10, in some aspects, process 1000 may include performing a link addition for one or more first candidate AP MLDs selected from the one or more candidate AP MLDs (block 1020). For example, the AP (e.g., using communication manager 1306, depicted in FIG. 13) may perform a link addition for one or more first candidate AP MLDs selected from the one or more candidate AP MLDs, as described above.

As further shown in FIG. 10, in some aspects, process 1000 may include transmitting a first response message that indicates that the one or more first candidate AP MLDs are prepared for the service transition (block 1030). For example, the AP (e.g., using transmission component 1304 and/or communication manager 1306, depicted in FIG. 13) may transmit a first response message that indicates that the one or more first candidate AP MLDs are prepared for the service transition, as described above.

Process 1000 may include additional aspects, such as any single aspect or any combination of aspects described below and/or in connection with one or more other processes described elsewhere herein.

In a first aspect, performing the link addition includes transmitting a request to add links to the one or more first candidate AP MLDs to multi-link set up links.

In a second aspect, alone or in combination with the first aspect, process 1000 includes receiving a second request message, and transmitting a second response message that indicates completion of the service transition to the second AP MLD.

In a third aspect, alone or in combination with one or more of the first and second aspects, process 1000 includes coordinating with the one or more candidate AP MLDs.

In a fourth aspect, alone or in combination with one or more of the first through third aspects, the first response message includes a list of the one or more first candidate AP MLDs that are prepared and able to accept a wireless device.

In a fifth aspect, alone or in combination with one or more of the first through fourth aspects, process 1000 includes receiving a second request message to service transition to the second AP MLD, which is on the list, or to modify the list.

In a sixth aspect, alone or in combination with one or more of the first through fifth aspects, the first response message indicates a network ranking of AP MLDs by the first AP MLD.

In a seventh aspect, alone or in combination with one or more of the first through sixth aspects, process 1000 includes deleting links of the first AP MLD from multi-link setup links.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

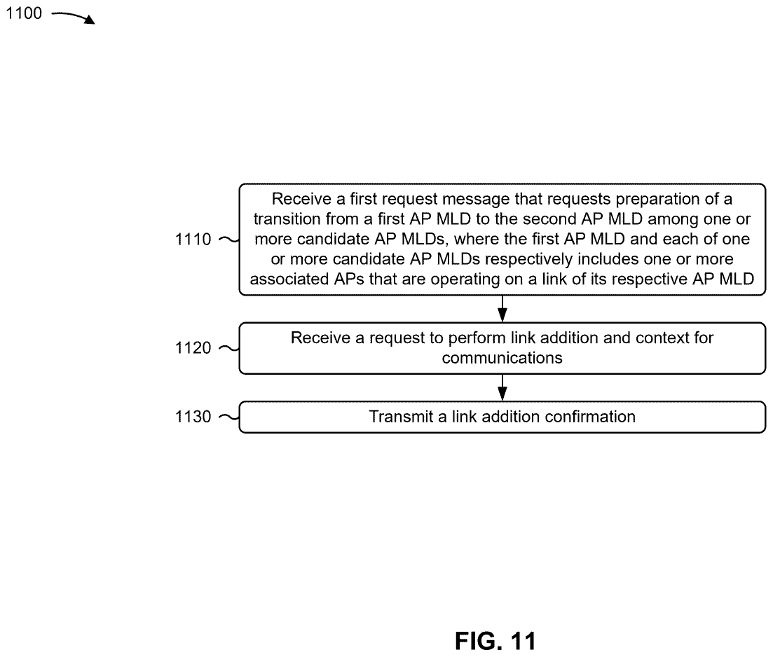

FIG. 11 is a diagram illustrating an example process 1100 performed, for example, at an AP or an apparatus of an AP. Example process 1100 is an example where the apparatus or the AP (e.g., AP MLD 320) performs operations associated with seamless roaming.

As shown in FIG. 11, in some aspects, process 1100 may include receiving a first request message that requests preparation of a service transition from a first AP MLD to the second AP MLD among one or more candidate AP MLDs, where the first AP MLD and each of one or more candidate AP MLDs respectively includes one or more associated APs that are operating on a link of its respective AP MLD (block 1110). For example, the AP (e.g., using reception component 1302 and/or communication manager 1306, depicted in FIG. 13) may receive a first request message that requests preparation of a service transition from a first AP MLD to the second AP MLD among one or more candidate AP MLDs, where the first AP MLD and each of one or more candidate AP MLDs respectively includes one or more associated APs that are operating on a link of its respective AP MLD, as described above.

As further shown in FIG. 11, in some aspects, process 1100 may include receiving a request to perform link addition and context for communications (block 1120). For example, the AP (e.g., using reception component 1302 and/or communication manager 1306, depicted in FIG. 13) may receive a request to perform link addition and context for communications, as described above.

As further shown in FIG. 11, in some aspects, process 1100 may include transmitting a link addition confirmation (block 1130). For example, the AP (e.g., using transmission component 1304 and/or communication manager 1306, depicted in FIG. 13) may transmit a link addition confirmation, as described above.

Process 1100 may include additional aspects, such as any single aspect or any combination of aspects described below and/or in connection with one or more other processes described elsewhere herein.

In a first aspect, process 1100 includes receiving a second request message, and transmitting a second response message that indicates completion of the service transition, based at least in part on a determination that the second request message is received within a timeout duration.

In a second aspect, alone or in combination with the first aspect, process 1100 includes receiving a second request message, and validating the second request message using a sequence number, a packet number, or a transaction token obtained from the first AP MLD.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 shows a flowchart illustrating an example process 900 performable by or at a wireless STA (e.g., client 310) that supports seamless roaming, in accordance with the present disclosure. The operations of the process 900 may be implemented by a wireless STA or its components as described herein, such as the communication manager 1206. For example, the process 900 may be performed by a wireless communication device, such as the wireless communication device 1200 described with reference to FIG. 12, operating as or within a wireless STA. In some examples, the process 900 may be performed by a wireless STA such as one of the STAs 104 described with reference to FIG. 1.

In some examples, the transmission component 1204 of the wireless STA may transmit a first request message that requests preparation of a service transition from a first AP MLD to a second AP MLD among one or more candidate AP MLDs, where the first AP MLD and each of one or more candidate AP MLDs respectively includes one or more associated APs that are operating on a link of its respective AP MLD. The reception component 1202 may receive a first response message that indicates that one or more first candidate AP MLDs, among the one or more candidate AP MLDs, are prepared for the service transition. The transmission component 1204 may transmit a second request message to the first AP MLD or the second AP MLD, where the second AP MLD is among the one or more first candidate AP MLDs. The reception component 1202 may receive a second response message that indicates completion of the service transition to the second AP MLD and that the second AP MLD is ready for data communications.

The wireless device 1200 includes a reception component 1202, a transmission component 1204, and a communication manager 1206. Portions of one or more of the components 1202, 1204, and 1206 may be implemented at least in part in hardware or firmware. For example, the communication manager 1206 may be implemented at least in part by a processor or a modem. In some examples, portions of one or more of the components 1202, 1204, and 1206 may be implemented at least in part by a processor and software in the form of processor-executable code stored in a memory.

In some examples, the wireless device 1200 is configured to perform the process 900 described with reference to FIG. 9. The wireless device 1200 may include one or more chips, SoCs, chipsets, packages, components or devices that individually or collectively constitute or comprise a processing system. The processing system may interface with other components of the wireless device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless device 1200 may transmit the information output from the chip. In such an example, the second interface may refer to an interface between the processing system of the chip and a reception component, such that the wireless device 1200 may receive information that is passed to the processing system. In some such examples, the first interface also may obtain information, such as from the transmission component, and the second interface also may output information, such as to the reception component.

The processing system of the wireless device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

FIG. 13 shows a block diagram of an example AP 1300 that supports seamless roaming. AP 1300 may support process 1000 or process 1100 performable by or at an AP 1300 (e.g., AP MLD 315, AP MLD 320) that supports seamless roaming, in accordance with the present disclosure. In some examples, the AP 1300 may be an AP, such as the AP 102 described with reference to FIG. 1. In some other examples, the AP can be an AP that includes such a processing system and other components including multiple antennas. The AP 1300 is capable of transmitting and receiving wireless communications in the form of, for example, wireless packets. For example, the AP 1300 can be configurable or configured to transmit and receive packets in the form of physical layer PPDUs and MPDUs conforming to one or more of the IEEE 802.11 family of wireless communication protocol standards. In some other examples, the AP 1300 can be configurable or configured to transmit and receive signals and communications conforming to one or more 3GPP specifications including those for 5G NR or 6G. In some examples, the AP 1300 also includes or can be coupled with one or more application processors which may be further coupled with one or more other memories. In some examples, the AP 1300 further includes at least one external network interface coupled with the processing system that enables communication with a core network or backhaul network that enables the AP 1300 to gain access to external networks including the Internet.

The AP 1300 includes a reception component 1302, a transmission component 1304, and a communication manager 1306. Portions of one or more of the components 1302, 1304, and 1306 may be implemented at least in part in hardware or firmware. For example, the communication manager 1306 may be implemented at least in part by a processor or a modem. In some examples, portions of one or more of the components 1302, 1304, and 1306 may be implemented at least in part by a processor and software in the form of processor-executable code stored in a memory.

In some aspects as a current AP MLD, the reception component 1302 may receive a first request message that requests preparation of a service transition from the first AP MLD to a second AP MLD among one or more candidate AP MLDs, where the first AP MLD and each of one or more candidate AP MLDs respectively includes one or more associated APs that are operating on a link of its respective AP MLD. The communication manager 1306 and the transmission component 1304 may perform a link addition for one or more first candidate AP MLDs selected from the one or more candidate AP MLDs. The transmission component 1304 may transmit a first response message that indicates that the one or more first candidate AP MLDs are prepared for the service transition.

In some aspects as a target AP MLD, the reception component 1302 may transmit a first request message that requests preparation of a service transition from a first AP MLD to the second AP MLD among one or more candidate AP MLDs, where the first AP MLD and each of one or more candidate AP MLDs respectively includes one or more associated APs that are operating on a link of its respective AP MLD. The reception component 1302 may receive a request to perform link addition and context for communications. The transmission component 1304 may transmit a link addition confirmation.

In some examples, the AP 1300 is configured to perform the process 1000 and the process 1100 described with reference to FIGS. 10 and 11. The AP 1300 may include one or more chips, SoCs, chipsets, packages, components or devices that individually or collectively constitute or comprise a processing system. The processing system may interface with other components of the AP 1300, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the AP 1300 may transmit the information output from the chip. In such an example, the second interface may refer to an interface between the processing system of the chip and a reception component, such that the AP 1300 may receive information that is passed to the processing system. In some such examples, the first interface also may obtain information, such as from the transmission component, and the second interface also may output information, such as to the reception component.

The processing system includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

The following provides an overview of some Aspects of the present disclosure:

Aspect 1: A method of wireless communication performed by a wireless device, comprising: transmitting a first request message that requests preparation of a service transition from a first access point (AP) multi-link device (MLD) to a second AP MLD among one or more candidate AP MLDs, wherein the first AP MLD and each of one or more candidate AP MLDs respectively includes one or more associated APs that are operating on a link of its respective AP MLD; receiving a first response message that indicates that one candidate AP MLD, among the one or more candidate AP MLDs, is the second AP MLD prepared for the service transition; transmitting a second request message to the first AP MLD or the second AP MLD; and receiving a second response message that indicates completion of the service transition to the second AP MLD and that the second AP MLD is ready for data communications.

Aspect 2: The method of Aspect 1, wherein the first request message includes a ranking of AP MLDs.

Aspect 3: The method of Aspect 2, wherein the ranking includes a set of sub-element values or positions for the AP MLDs.

Aspect 4: The method of Aspect 2, wherein the first request message indicates whether only AP MLDs from the ranking are to be considered for selection of the second AP MLD or whether additional candidate AP MLDs are to be considered for the selection.

Aspect 5: The method of any of Aspects 1-4, further comprising communicating a message on a link of the second AP MLD after receiving the second response message.

Aspect 6: The method of any of Aspects 1-5, wherein the first request message is associated with all links of the one or more candidate AP MLDs.

Aspect 7: The method of any of Aspects 1-6, wherein the first request message indicates one or more bands of interest of the wireless device.

Aspect 8: The method of any of Aspects 1-7, wherein the first request message indicates a traffic-identifier-to-link mapping for added links of the second AP MLD.

Aspect 9: The method of any of Aspects 1-8, wherein the first request message indicates a first context transfer to the one or more first candidate AP MLDs, and wherein the second request message indicates one or more of a second context transfer, a request for a mapping change, or a transition of service to the second AP MLD.

Aspect 10: The method of any of Aspects 1-9, wherein the first request message indicates how a pending downlink is to be handled.

Aspect 11: The method of any of Aspects 1-10, wherein the first request message uses a traffic-identifier-to-link mapping request frame, a link reconfiguration request frame, or a frame specific to transition preparation.

Aspect 12: The method of any of Aspects 1-11, wherein the first request message indicates one or more of a set of links to wake or a set of links to cause to sleep.

Aspect 13: A method of wireless communication performed by a first access point (AP) multi-link device (MLD), comprising: receiving a first request message that requests preparation of a service transition from the first AP MLD to a second AP MLD among one or more candidate AP MLDs, wherein the first AP MLD and each of one or more candidate AP MLDs respectively includes one or more associated APs that are operating on a link of its respective AP MLD; performing a link addition for one or more first candidate AP MLDs selected from the one or more candidate AP MLDs; and transmitting a first response message that indicates that the one or more first candidate AP MLDs are prepared for the service transition.

Aspect 14: The method of Aspect 13, wherein performing the link addition includes transmitting a request to add links to the one or more first candidate AP MLDs to multi-link set up links.

Aspect 15: The method of any of Aspects 13-14, further comprising: receiving a second request message; and transmitting a second response message that indicates completion of the service transition to the second AP MLD.

Aspect 16: The method of any of Aspects 13-15, further comprising coordinating with the one or more candidate AP MLDs.

Aspect 17: The method of Aspect 16, wherein the first response message includes a list of the one or more first candidate AP MLDs that are prepared and able to accept a wireless device.

Aspect 18: The method of Aspect 17, further comprising receiving a second request message to service transition to the second AP MLD, which is on the list, or to modify the list.

Aspect 19: The method of any of Aspects 13-18, wherein the first response message indicates a network ranking of AP MLDs by the first AP MLD.

Aspect 20: The method of any of Aspects 13-19, further comprising deleting links of the first AP MLD from multi-link setup links.

Aspect 21: A method of wireless communication performed by a second access point (AP) multi-link device (MLD), comprising: receiving a first request message that requests preparation of a service transition from a first AP MLD to the second AP MLD, wherein the second AP MLD is among one or more candidate AP MLDs, and wherein the first AP MLD and each of one or more candidate AP MLDs respectively includes one or more associated APs that are operating on a link of its respective AP MLD; receiving a request to perform link addition and context for communications; and transmitting a link addition confirmation.

Aspect 22: The method of Aspect 21, further comprising: receiving a second request message; and transmitting a second response message that indicates completion of the service transition, based at least in part on a determination that the second request message is received within a timeout duration.

Aspect 23: The method of any of Aspects 21-22, further comprising: receiving a second request message; and validating the second request message using a sequence number, a packet number, or a transaction token obtained from the first AP MLD.

Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-23.

Aspect 25: An apparatus for wireless communication at a device, the apparatus comprising one or more memories and one or more processors coupled to the one or more memories, the one or more processors configured to cause the device to perform the method of one or more of Aspects 1-23.

Aspect 26: An apparatus for wireless communication, the apparatus comprising at least one means for performing the method of one or more of Aspects 1-23.

Aspect 27: A non-transitory computer-readable medium storing code for wireless communication, the code comprising instructions executable by one or more processors to perform the method of one or more of Aspects 1-23.

Aspect 28: A non-transitory computer-readable medium storing a set of instructions for wireless communication, the set of instructions comprising one or more instructions that, when executed by one or more processors of a device, cause the device to perform the method of one or more of Aspects 1-23.

Aspect 29: A device for wireless communication, the device comprising a processing system that includes one or more processors and one or more memories coupled with the one or more processors, the processing system configured to cause the device to perform the method of one or more of Aspects 1-23.

Aspect 30: An apparatus for wireless communication at a device, the apparatus comprising one or more memories and one or more processors coupled to the one or more memories, the one or more processors individually or collectively configured to cause the device to perform the method of one or more of Aspects 1-23.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication at a wireless device, comprising:
one or more memories; and
one or more processors coupled to the one or more memories, the one or more processors individually or collectively configured to cause the wireless device to:
transmit a first request message that requests preparation of a service transition from a first access point (AP) multi-link device (MLD) to a second AP MLD among one or more candidate AP MLDs, wherein the first AP MLD and each of one or more candidate AP MLDs respectively includes one or more associated APs that are operating on a link of its respective AP MLD;
receive a first response message that indicates that one candidate AP MLD, among the one or more candidate AP MLDs, is the second AP MLD prepared for the service transition;
transmit a second request message to the first AP MLD or the second AP MLD; and
receive a second response message that indicates completion of the service transition to the second AP MLD and that the second AP MLD is ready for data communications.

2. The apparatus of claim 1, wherein the first request message includes a ranking of AP MLDs, and wherein the ranking includes a set of sub-element values or positions for the AP MLDs.

3. The apparatus of claim 2, wherein the first request message indicates whether only AP MLDs from the ranking are to be considered for selection of the second AP MLD or whether additional candidate AP MLDs are to be considered for the selection.

4. The apparatus of claim 1, wherein the one or more processors are individually or collectively configured to cause the wireless device to communicate a message on a link of the second AP MLD after receiving the second response message.

5. The apparatus of claim 1, wherein the first request message is associated with all links of the one or more candidate AP MLDs.

6. The apparatus of claim 1, wherein the first request message indicates one or more bands of interest of the wireless device.

7. The apparatus of claim 1, wherein the first request message indicates a traffic-identifier-to-link mapping for added links of the second AP MLD.

8. The apparatus of claim 1, wherein the first request message indicates a first context transfer to the one or more first candidate AP MLDs, and wherein the second request message indicates one or more of a second context transfer, a request for a mapping change, or a transition of service to the second AP MLD.

9. The apparatus of claim 1, wherein the first request message indicates how a pending downlink is to be handled.

10. The apparatus of claim 1, wherein the first request message uses a traffic-identifier-to-link mapping request frame, a link reconfiguration request frame, or a frame specific to transition preparation.

11. An apparatus for wireless communication at a first access point (AP) multi-link device (MLD), comprising:
one or more memories; and
one or more processors, coupled to the one or more memories, individually or collectively configured to cause the AP to:
receive a first request message that requests preparation of a service transition from the first AP MLD to a second AP MLD among one or more candidate AP MLDs, wherein the first AP MLD and each of one or more candidate AP MLDs respectively includes one or more associated APs that are operating on a link of its respective AP MLD;
perform a link addition for one or more first candidate AP MLDs selected from the one or more candidate AP MLDs; and
transmit a first response message that indicates that the one or more first candidate AP MLDs are prepared for the service transition.

12. The apparatus of claim 11, wherein to perform the link addition, the one or more processors are individually or collectively configured to cause the first AP MLD to transmit a request to add links to the one or more first candidate AP MLDs to multi-link set up links.

13. The apparatus of claim 11, wherein the one or more processors are individually or collectively configured to cause the first AP MLD to:
receive a second request message; and
transmit a second response message that indicates completion of the service transition to the second AP MLD.

14. The apparatus of claim 11, wherein the one or more processors are individually or collectively configured to cause the first AP MLD to coordinate with the one or more candidate AP MLDs.

15. The apparatus of claim 11, wherein the first response message includes a list of the one or more first candidate AP MLDs that are prepared and able to accept a wireless device, and wherein the one or more processors are individually or collectively configured to cause the first AP MLD to receive a second request message to service transition to the second AP MLD, which is on the list, or to modify the list.

16. The apparatus of claim 11, wherein the first response message indicates a network ranking of AP MLDs by the first AP MLD.

17. The apparatus of claim 11, wherein the one or more processors are individually or collectively configured to cause the first AP MLD to delete links of the first AP MLD from multi-link setup links.

18. An apparatus for wireless communication at a second access point (AP) multi-link device (MLD), comprising:
one or more memories; and
one or more processors, coupled to the one or more memories, individually or collectively configured to cause the second AP MLD to:
receive a first request message that requests preparation of a service transition from a first AP MLD to the second AP MLD, wherein the second AP MLD is among one or more candidate AP MLDs, and wherein the first AP MLD and each of one or more candidate AP MLDs respectively includes one or more associated APs that are operating on a link of its respective AP MLD;
receive a request to perform link addition and context for communications; and
transmit a link addition confirmation.

19. The apparatus of claim 18, wherein the one or more processors are individually or collectively configured to cause the second AP MLD to:
receive a second request message; and
transmit a second response message that indicates completion of the service transition, based at least in part on a determination that the second request message is received within a timeout duration.

20. The apparatus of claim 18, wherein the one or more processors are individually or collectively configured to cause the second AP MLD to:
receive a second request message; and
validate the second request message using a sequence number, a packet number, or a transaction token obtained from the first AP MLD.
